(19) United States
(12) Patent Application Publication
(10) Pub. No.: US 2013/0056978 A1
(43) Pub. Date: Mar. 7, 2013

(54) FLUID COUPLING

(71) Applicants: Jonathan Clark Swift, Denver, CO (US); Martin Meyer, Swisttal-Heimerzheim (DE); Randall Mark Leasure, Monument, CO (US); Vincent James Hainsby, St. Neots (GB)

(72) Inventors: Jonathan Clark Swift, Denver, CO (US); Martin Meyer, Swisttal-Heimerzheim (DE); Randall Mark Leasure, Monument, CO (US); Vincent James Hainsby, St. Neots (GB)

(73) Assignee: THE GATES CORPORATION, Denver, CO (US)

(21) Appl. No.: 13/610,557

(22) Filed: Sep. 11, 2012

Related U.S. Application Data
(63) Continuation-in-part of application No. 13/448,004, filed on Apr. 16, 2012.
Application No. 13/448,004 is a continuation of application No. 12/592,397, filed on Nov. 24, 2009, now abandoned.

(51) Int. Cl. F16L 25/00

(52) U.S. Cl. 285/332

(57) ABSTRACT

An integrally formed male tube end configured for selective engagement to a female port surface to create a fluid seal is provided. The tube end has a leading edge, an outer wall, and an inner wall. The outer wall of the male tube end includes a male tapered surface, a shoulder, and a substantially cylindrical surface positioned between the male tapered surface and the shoulder. The inner wall of the tube end may include an annular cavity to allow deflection and enhanced sealing between the male sealing surface and the female tapered surface.

### CROSS-REFERENCE TO RELATED APPLICATIONS

This application is a continuation-in-part of U.S. patent application Ser. No. 13/448,004, filed Apr. 16, 2012, which is a continuation of U.S. patent application Ser. No. 12/592,397, filed Nov. 24, 2009, the entire disclosures of which are incorporated herein by reference.

### FIELD

The present disclosure relates generally to a fluid coupling, and more specifically to a metallic fluid coupling utilizing a formed tube male end and a mating female end.

### BACKGROUND

Generally, for the purpose of forming a tube joint or hose coupling, a male portion engages a port. The shape of the male portion and cooperating port are designed to allow ease of connection while providing a suitable pressure seal.

Various joints and coupling are known, however, in each instance a particular male connector will only mate with the appropriate corresponding same style port. In other words, mixing connector styles is not possible since one style is not interchangeable with another, which limits system flexibility. Hence, it is not possible to use an SAE MALE BOSS connector with a SAE 37 DEGREE port.

It is known that standard SAE male boss fittings are susceptible to leakage after pressure, temperature and vibration excursions. This can cause equipment manufacturers to either over torque SAE male boss fittings (potentially resulting in stripped threads) or to use more costly longer threads (SAE male boss heavy) particularly when ports are machined into aluminum.

It is also known that male boss swivel port fittings (SAE reference) are prone to leakage and damage after pressure, temperature and vibration excursions. These issues can be accentuated by the designs of these fittings which comprise of a threaded male stud with an o-ring followed by a clinched washer followed by a second thread and lock nut. The weak element is the washer clinching process, if this is not done accurately gaps behind the o-ring can exist which lead to o-ring extrusion further shortening life of the fitting.

Representative of the art is U.S. Pat. No. 5,516,157 which discloses an improved hydraulic coupling which forms contact seals to fluidly connect a tapered port with a tube having a threaded connecting portion. The contact seals may be metal-to-metal seals, or alternatively may include a resin polymer element. For connecting a tube directly in the port, one embodiment of the invention includes an outwardly extending lip on an expanded portion of the tube and a tube nut rim wherein the tube nut engages the expanded portion and by tightening the tube nut, the tube lip deforms on the tapered port and the tube nut rim deforms on both the tapered port and the tube. Optionally, o-rings may be added to provide additional seals. The coupling may be designed not to seal without the application of tool generated torques.

A fluid coupling generally comprises a male component and a female component. In many circumstances, at least one of the components is attached to a tube. Conventionally a brazing, crimping, machining, and/or welding process is utilized to attach the male and/or female component to the tube.

The brazing process generally comprises attaching a machined male or female component to an end of a tube with a braze ring. The component typically is manufactured to a high tolerance specification, and a braze ring is seated against an internal shoulder of the component. The highly-toleranced component is then press fit onto an end of the tube so that the braze ring is positioned between the internal shoulder of the component and the end of the tube. The region around the braze ring is then heated to a brazing temperature to melt the braze ring and allow the melted braze ring to flow between the component and the tube end. Once the heat is removed and the region is cooled, the melted braze solidifies to join the component to the tube. Downsides of the brazing process includes the high level of manufacturing tolerance required for the component, the high cost of the brazing process, and the difficulty of controlling the brazing process.

The crimping process generally comprises crimping a machined male or female component to an end of a tube. Similar to the brazing process, the component typically is manufactured to a high tolerance specification. The component generally includes a tubular member configured to fit around an outer periphery of an end of the tube, and the tubular member is crimped to the end of the tube to join the component to the tube. Downsides of the crimping process include the high level of manufacturing tolerance on the component, and complications that may occur due to crimping the component to the tube.

The machining process generally comprises machining corresponding seal surfaces into coupling components. To feasibly machine a tapered surface into a coupling component, the component must have a minimum hardness. This hardness requirement reduces the effectiveness of the seal, as a leakproof seal generally requires the local deformation of one member of the connection to conform to the surface irregularities of the other member. To overcome the generally non-deformable behavior of the machined surfaces, a sealing element, such as an o-ring, generally is utilized to create a seal between the machined surfaces. Downsides of the machining process include the generally rigid sealing surfaces and the associated sealing element, which increases the cost of the fluid coupling and must be replaced over time due to wear, along with other issues.

The welding process generally comprises welding a machined male or female component to an end of a tube. Similar to the brazing process, the component typically is manufactured to a high tolerance specification. After manufacturing, the component is welded to an end of the tube. Downsides of the welding process include the high level of manufacturing tolerance on the component, and complications that may occur during welding the component to the tube.

### SUMMARY

A primary aspect of the disclosure is to provide a hybrid tube connector port comprising a first and second tapered surface for engaging different types of tube connectors.

Other aspects of the disclosure will be pointed out or made obvious by the following description of the invention and the accompanying drawings.

In various embodiments, the invention comprises a hybrid port comprising a bore having a diameter approximately corresponding to the diameter of a tube, a first tapered surface having a cone angle a of approximately 37° for engaging a SAE 37 DEGREE connector, a second tapered surface having a cone angle β of approximately 12° for engaging an SAE MALE BOSS connector, the first tapered surface disposed immediately proximate to the bore, and a threaded inner surface disposed axially between the first tapered surface and the second tapered surface.

It is one aspect of the present disclosure to provide a fluid coupling comprising a male portion, a female portion, and a nut configured to interconnect the male and female portions. The male portion generally includes a tapered surface configured to sealing engage a female portion. In some embodiments, the male portion comprises an integrally formed tube end, which eliminates the complications and costs associated with a brazing, crimping, machining, and/or welding process. The female portion generally includes a tapered surface configured to sealing engage a male portion. In some embodiments, the female portion comprises a female adapter, socket, machined port, or any other suitable female portion known in the art. The nut generally is configured to interconnect the male and female portions to create a seal between substantially complementary sealing surfaces. In some embodiments, the nut comprises any suitable nut known in the art. For example, in one embodiment, the nut comprises an externally-threaded nut disposed entirely about the male portion and configured to push the male seal surface into the female seal surface. In another embodiment, the nut comprises an internally-threaded nut retained on the male portion and configured to pull a male seal surface and a female seal surface together to create a seal.

It is another aspect of the present disclosure to provide a male portion of a fluid coupling that is integrally formed on a tube, and generally referred to as a formed tube end herein. The formed tube end may include a male tapered surface configured to sealingly engage a female seal surface to create a seal. The male tapered surface may be formed in various shapes. For example, in some embodiments, the male tapered surface may be conical, spherical, or any other suitable shape utilized in the art. If conical, the male tapered surface may be formed at various angular orientations relative to a longitudinal axis, or centerline, of the tube. For example, in some embodiments, the tapered surface has a cone angle of between approximately 27 degrees and approximately 31 degrees relative to the longitudinal axis, or an included cone angle of between approximately 54 degrees and approximately 62 degrees. In some embodiments, the tapered surface has a cone angle of between approximately 27.5 degrees and approximately 30 degrees relative to the longitudinal axis, or an included cone angle of between approximately 55 degrees and approximately 60 degrees. In some embodiments, the tapered surface has a cone angle of approximately 29.5 degrees relative to the longitudinal axis, or an included cone angle of approximately 59 degrees. The tapered surface may transition into leading edge of tube end. In some embodiments, the male tapered surface is constructed to have an included angle that is slightly less than an included angle of a corresponding female tapered surface to ensure that the male tapered surface seats on an inner diameter of the female tapered surface so that fluid sealing takes place at a minimum diameter of the mating surfaces.

It is another aspect of the present disclosure to provide a male portion of a fluid coupling that is resiliently deformable to create a seal. In some embodiments, the male portion comprises a formed tube end that has a male tapered surface associated with an outer wall of the tube. In some embodiments, the formed tube end may include a cavity, or recess, that extends around an inner periphery of the tube end. In embodiments, the cavity is formed during a manufacturing process in which an end of a tube is deformed to create a male tapered sealing surface. The cavity may be annular and may be positioned substantially between a leading edge of the tube and a shoulder of the tube. The cavity may increase the elastic deformation of the formed tube end when exposed to compression forces during union of a male and female portion, thereby increasing the effectiveness of the seal.

It is another aspect of the present disclosure to provide a fluid coupling including a male portion that has a different hardness than a female portion to enhance a seal created between the male and female portions. The male portion may comprise a tube having an integrally formed tube end. In some embodiments, the tube is softer than a female portion. The difference in hardness may be achieved through material selection, heat treating, or any other suitable process known in the art. In some embodiments, the female portion, which may be machined from steel, has a Rockwell B Hardness in the range of about 80 to about 110. In some embodiments, the tube has a Rockwell B Hardness in the range of about 20 to about 60. By providing a fluid coupling in some embodiments that utilizes a male portion and a female portion with differing hardness, the softer portion of the fluid coupling generally conforms to the minor surface irregularities of the other portion, thereby creating a fluid-tight seal. In at least these embodiments, other sealing elements, such as o-rings or crush washers, are not needed.

It is yet another aspect of the present disclosure to provide a fluid coupling constructed of commonly known materials. In various embodiments, the fluid coupling comprises a male portion, a female portion, and a nut, all of which may be constructed of metallic and/or non-metallic materials. In some embodiments, the male portion, the female portion, and the nut are constructed of steel, aluminum, brass, combinations thereof, or any other suitable material known in the art. In some embodiments, the male portion and the female portion are both metallic, thereby creating a metal-to-metal seal when joined together. In some embodiments, the male portion comprises a different material than the female portion. For example, the male portion may be constructed of a material with a different hardness than the female portion. In some embodiments, the male portion is constructed of a softer material than the female portion of the fluid coupling. In some embodiments, the male portion is constructed of a low carbon steel that is malleable and ductile. In some embodiments, the male portion comprises a tube having an integrally formed male end.

It is another aspect of the present disclosure to provide a male portion of a fluid coupling, particularly a formed tube end, having reduced manufacturing costs. In some embodiments, a male portion of a fluid coupling is integrally formed on an end of a tube, thereby eliminating the complications and costs associated with a brazing, crimping, machining, and/or welding process. In some embodiments, a punch is utilized to integrally form a male tapered surface in an end of a tube. The punch may include a female tapered surface configured to contact and deform the end of the tube. The punch and/or tube may be axially displaceable along a longitudinal axis of the tube. In some embodiments, a die is disposed about an external surface, or wall, of the tube so that an end of the tube extends beyond an end of the die. The end of the die may include a recessed area having surfaces configured to seat a deformed portion of the tube to form a shoulder and a cylindrical surface in an outer wall of the tube end. The compressive forces exerted on the tube end by the punch and/or die may form an annular cavity in an inner wall of the tube end. In some embodiments, the die and/or tube are held stationary during the forming process.

It is yet another aspect of the present disclosure to provide a fluid coupling that complies with a common pipe standard. For example, a male and a female portion of a fluid coupling may be provided that complies with a British Standard Pipe specification, including taper and thread dimensions. In some embodiments, a male portion of a fluid coupling is integrally formed on a tube. The features formed on or associated with the tube end, including a taper and/or a thread, may be based on an applicable pipe specification, such as a British Standard Pipe specification.

The present disclosure can provide a number of advantages depending on the particular aspect, embodiment, and/or configuration. For example, embodiments of the present disclosure provide a fluid coupling utilizing an integrally formed tube end as a male portion, thereby eliminating the need for a separate component that has to be attached to a tube. In addition, by integrally forming the tube end, the issues and costs associated with a brazing, crimping, machining, and/or welding process can be substantially eliminated. For example, by forming a male portion integral to a tube, fewer components and critical tolerances are required during the manufacturing process, thereby reducing the opportunity for errors during manufacturing and reducing the manufacturing costs. In addition, forming a male portion integral to a tube eliminates the need for brazing or welding, which can be expensive, difficult to control, and can present environmental hazards. These and other advantages will be apparent from the disclosure.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended and can be used interchangeably herein.

It shall be understood that the term “means,” as used herein, shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the claimed subject matter is intended by either the inclusion or non-inclusion of elements, components, etc. in this Summary. Moreover, reference made herein to “the present invention” or aspects thereof should be understood to mean certain embodiments of the present disclosure and should not necessarily be construed as limiting all embodiments to a particular description. The above and other objects advantages and features will become more readily understood from a consideration of the following detailed description when taken together with the accompanying drawings.

### BRIEF DESCRIPTION OF THE DRAWINGS

The accompanying drawings, which are incorporated in and constitute a part of the specification, illustrate embodiments of the disclosure and together with the general description given above and the detailed description of the drawings given below, serve to explain the principles of these embodiments.

The accompanying drawings, which are incorporated in and form a part of the specification, illustrate preferred embodiments of the present invention, and together with a description, serve to explain the principles of the invention.

FIG. 1(A) and FIG. 1(B) show the prior art;

FIG. 2(A) is a cross-sectional view of the inventive hybrid port;

FIG. 2(B) is a cross-sectional view of an alternate embodiment;

FIG. 2C is cross-sectional view of a hybrid port;

FIG. 2D a split cross-sectional view of a compact hybrid port with shorter threads;

FIG. 3 is a cross-sectional view of the port in FIG. 2A with an MJX tube attached;

FIG. 4A is a cross-sectional view of the port in FIG. 2A with the SAE male boss heavy duty attached;

FIG. 4B is a cross-sectional view of the port in FIG. 2A with the SAE male boss light duty;

FIG. 5 is a cross-sectional view of the port in FIG. 2D with a male SAE 45 fitting attached;

FIG. 6 is a cross-sectional view of a straight tubular coupling assembly engaged with the hybrid port;

FIG. 7 is a cross-sectional view of a bent tube assembly engaged with the hybrid port;

FIG. 8 is a cross-sectional view of a straight coupling assembly engaged with the hybrid port;

FIG. 9 is a cross-sectional view of the port in FIG. 2A with an MJX tube attached;

FIG. 10 is a cross-sectional view of the port in FIG. 2A with the SAE male boss light duty;

FIG. 11 is a partial cross-sectional view of a fluid coupling according to one embodiment of the present disclosure;

FIG. 12 is an enlarged view of the detail area identified in FIG. 1;

FIG. 13 is a partial cross-sectional view of the formed tube end shown in FIG. 1; and

FIG. 14 is a cross-sectional view of a fluid coupling according to one embodiment of the present disclosure.

It should be understood that the drawings are not necessarily to scale. In certain instances, details that are not necessary for an understanding of the disclosure or that render other details difficult to perceive may have been omitted. It should be understood that the claimed subject matter is not necessarily limited to the particular embodiments illustrated herein.

To assist in the understanding of the drawings, the following is a list of components and associated numbering found in the drawings:

| # | Element |
|---|---|
| A | Tapered surface |
| C | Cap |
| M | Male connector |
| N | Nut |
| O | O-ring |
| α | Cone angle |
| β | Cone angle |
| ω | Cone angle |
| R1 | Radius |
| R2 | Radius |
| RS | Receiving surface |
| R4 | Radius |
| 10 | Threaded surface |
| 11 | Tapered surface |
| 12 | Tapered surface |
| 13 | Tapered surface |
| 15 | Arcuate surface |
| 16 | Port surface |
| 20 | Swivel nut |
| 21 | Tubing |
| 21A | Tube thickness |
| 21B | Tube thickness |
| 22A | Tube end |
| 22B | Tube end |
| 22 | Cone |
| 23 | Swivel nut end |
| 24 | Metal to metal seal |
| 70 | Connector |
| 72 | Circumferential outer surface |
| 73 | Flange surface |
| 75 | O-ring |
| 100 | Port |
| 101 | Bore |
| 102 | Fluid coupling |
| 104 | Tube end |
| 106 | Female cone |
| 108 | Nut |
| 110 | Bore |
| 112 | Tube leading edge |
| 114 | Outer wall |
| 116 | Inner wall |
| 118 | Male tapered seal surface |
| 120 | Shoulder |
| 122 | Cylindrical surface |
| 124 | Annular cavity |
| 126 | Cylindrical surface |
| 128 | Female tapered surface |
| 130 | Bearing surface |
| 132 | Leading surface |
| 134 | Trailing surface |
| 138 | Externally threaded section |
| 140 | Internally threaded section |
| 150 | Surface |
| 151 | Arcuate surface |
| 200 | Port |
| 221 | Tube end |
| 250 | Male boss |
| 300 | Port |
| 350 | Male boss |
| 400 | Ferrule |
| 450 | Male fitting |
| 500 | Assembly |
| 501 | Tubing assembly |

### DETAILED DESCRIPTION

Although some embodiments will now be described with reference to the drawings, it should be understood that the embodiments shown are by way of example only and are merely illustrative of some of the many possible specific embodiments which can represent applications of the principles of the disclosure. Various changes and modifications, obvious to one skilled in the art to which the claimed subject matter pertains, are deemed to be within the spirit, scope and contemplation of the disclosure as further defined in the appended claims.

The inventive hybrid port allows different components to be used in a system.

In particular, a user is afforded flexibility in selecting components wherein for example a given style, for example, SAE MALE BOSS or SAE 37 DEGREE can each be connected to the hybrid port.

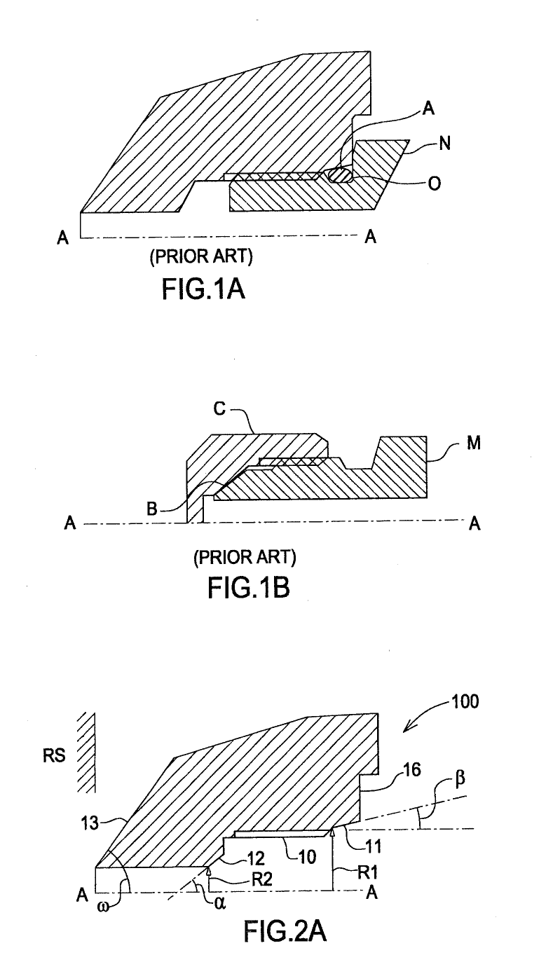

FIG. 1(A) and FIG. 1(B) each show the prior art. FIG. 1(A) shows a male boss (SAE MALE BOSS) standard port connector. A tapered surface A compresses an o-ring O against a nut N. FIG. 1(B) shows a cap C engaged with an SAE 37 Degree male connector

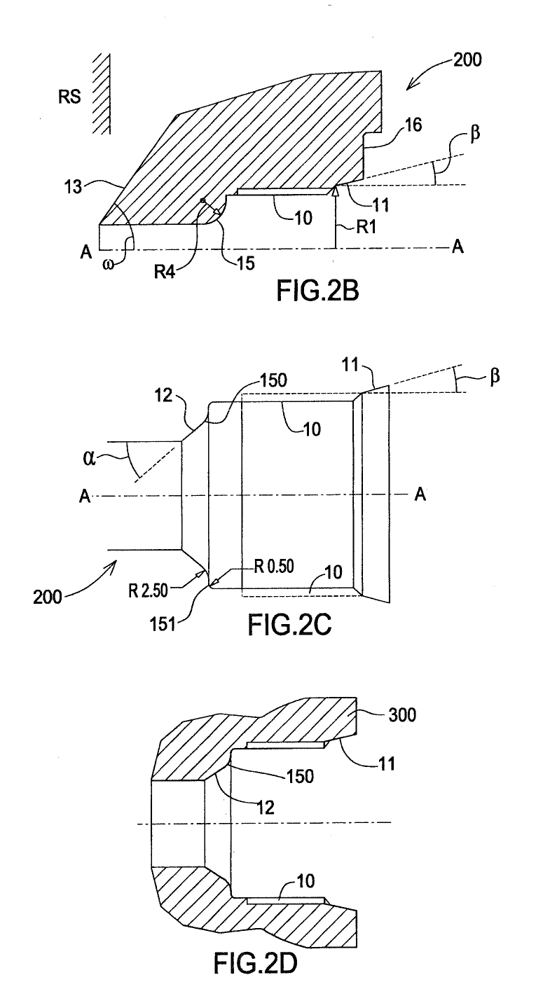

Each of FIGS. 2A and 2B depict an upper half of the hybrid port with respect to an axis A-A, the lower half being identical to the upper half as shown and therefore, the lower half is omitted.

FIG. 2(A) is a cross-sectional view of the inventive hybrid port. A male SAE 37 DEGREE component (not shown) will have a cone to seal engagement with surface 12.

The hybrid port comprises a threaded inner surface 10. Threaded surface 10 provides for a threaded engagement with any threaded tubing connector as described herein.

A tapered surface 11 comprises a cone angle β in the range of 11° to 16°. The preferred angle is 12°. Surface 11 is engagable with a male boss (SAE MALE BOSS) connector o-ring (not shown). The o-ring is known in the art.

A tapered surface 12 comprises a cone angle a of approximately 36.5° up to approximately 40°. The preferred angle is 37°. Surface 12 is engagable with an MJX tube cone (see FIG. 6). Surface 12 is immediately proximate to bore 101. Cone angle α may also comprise approximately 45° so that the connector can interface with a SAE 45 DEGREE Male fitting (not shown).

The radius R1 to surface 11 is greater than radius R2 to surface 12. No portion of surface 12 has a radius which exceeds a radius of surface 11. Radius R2 is one half the diameter of bore 101, see FIG. 6.

Threaded surface 10 is disposed axially with respect to longitudinal axis A-A between surface 11 and surface 12.

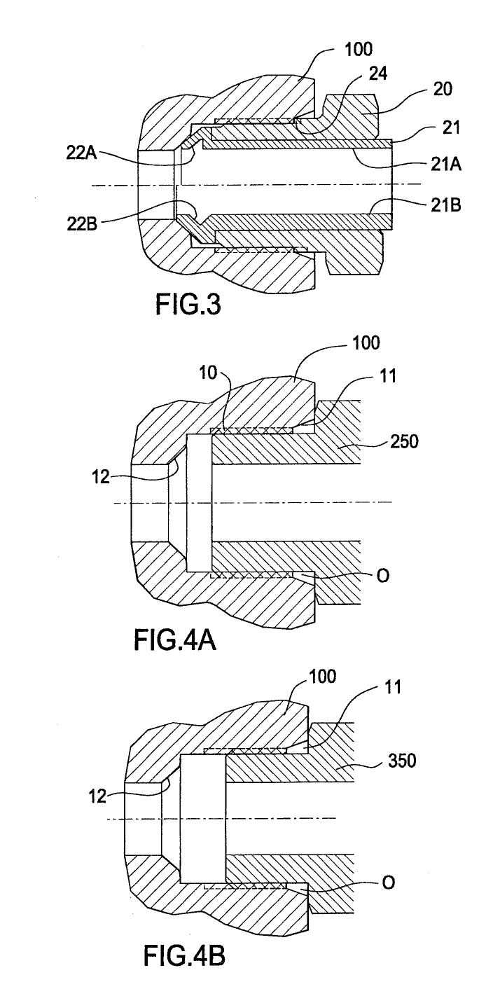

A tapered surface 13 comprises a cone angle co of approximately 60°, although any angle that would be suitable for a fillet weld is sufficient, for example between 30° and 60°. Surface 13 provides a weldment by which the hybrid port is welded to a receiving surface (RS), see FIG. 3. Weldment surface 13 is known in the art.

In an alternate embodiment the hybrid port is machined directly into the equipment instead of being welded, or is threaded into the equipment by threads on an outer surface.

FIG. 2(B) is a cross-sectional view of an alternate embodiment. In embodiment 200, arcuate surface 15 comprises an arc of radius R4. Surface 15 creates a ring contact with cone 22. This creates a contact arc (circular line) which increases the contact pressure per unit area, which in turn enhances sealing. The arcuate surface 15 will mate with any tube having a cone angle α, for example as described in FIG. 2(A). The embodiment in FIG. 2B and the embodiment in FIG. 2C are able to accept a SAE MALE BOSS fittings an 37 DEGREE male fitting, a 45 DEGREE male fitting and an MJX fitting with either a 45 degree cone or a 37 degree cone

FIG. 2(C) is cross-sectional view of a hybrid port. Radius (R) allows the part to engage several different cones. FIG. 2C is an alternate embodiment to FIG. 2B. This hybrid port has a surface 150 having a radius of approximately R2.50. However, the radius could be in the range of 0.25 mm up to greater than 20 mm depending upon the size of the port.

Surface 12 is disposed at an angle α to a centerline A-A. Surface 12 is connected to arcuate sealing surface 150. Surface 150 comprises a radius of R2.50. Surface 150 engages a tube cone to create a seal. Surface 150 is adjacent to arcuate surface 151 and is adjacent to surface 12. Surface 151 comprises a radius of R0.50, or in other words the radius of surface 150 is approximately 5× larger than the radius of surface 151.

FIG. 2(D) is cross-sectional view of a hybrid port. Radius (R) allows the part to engage several different cones. FIG. 2D is an alternate embodiment to FIG. 2C. This hybrid port is more compact and has a shorter thread allowing it to mate with a standard SAE male 37 and a standard SAE male 45 and an MJX and a Male Boss light fitting

Surface 12 is disposed at an angle α to a centerline A-A. Surface 12 engages an arcuate sealing surface 150. Surface 150 comprises a radius of R2.50. Surface 150 engages a tube to create a seal. Surface 150 is adjacent to arcuate surface 151 and is adjacent to surface 12. Surface 151 comprises a radius of R0.50, or in other words the radius of surface 150 is 5× larger than the radius of surface 151.

FIG. 3 is a cross-sectional view of the port in FIG. 2A with an MJX tube attached. MJX tubing on a swivel nut 20 is engaged with threaded surface 10. Surface 10 comprises a straight thread. Surface 10 may comprise either a left hand or right hand thread.

Reinforced cone 22 for tubing 21 is compressed between surface 12 and end 23 of swivel nut 20, thereby forming a metal to metal seal. Two different tube thicknesses are shown in FIG. 3, namely, 21A and 21B. Ends 22A and 22B engage surface 150. Each end 22A and 22b has a cone angle equal to a as described in FIG. 2A.

FIG. 4(A) is a cross-sectional view of the port in FIG. 2A with the SAE male boss heavy duty attached.

FIG. 4(B) is a cross-sectional view of the port in FIG. 2A with the SAE male boss light duty attached.

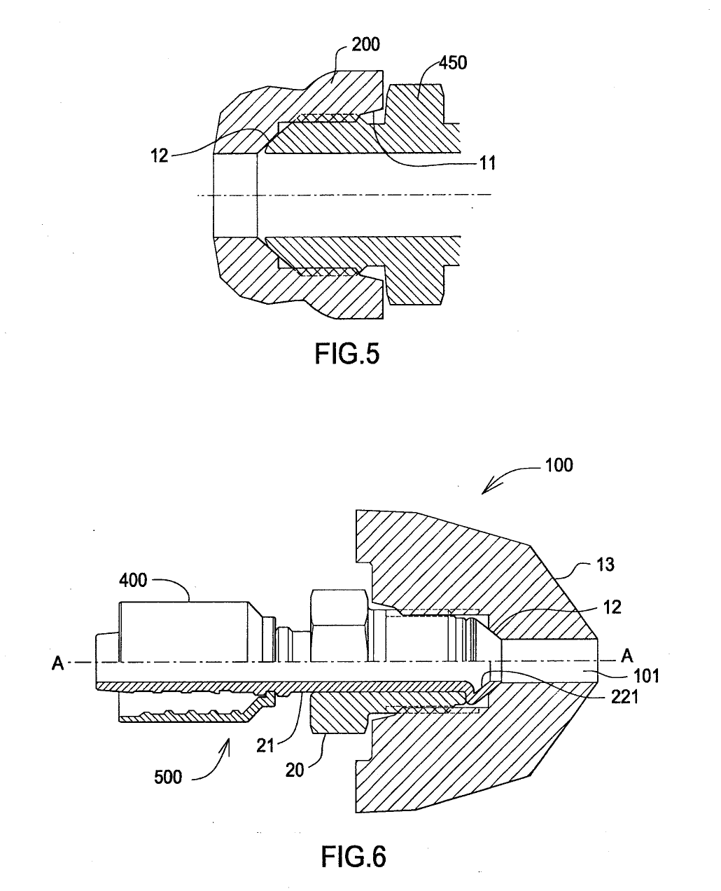

FIG. 5 is a cross-sectional view of the port in FIG. 2D with a male SAE 45 fitting attached. Note this hybrid port 200 will also work with a male SAE 37 fitting.

FIG. 6 is a cross-sectional view of a tubing assembly 501 engaged with the hybrid port 100. The tubing and connector assembly is as described in FIG. 3. Ferrule 400 is used to connect the assembly to a hose.

Assembly 500 is axially aligned along axis A-A. A bore 101 extends through the port whereby a fluid can flow through the port. Bore 101 having a diameter approximately corresponding to the diameter of tube 21.

The fluid can comprise hydraulic oil, oil, fuel, water, gases or any other fluid which is amenable to flow through tubes or hose.

The new design overcomes the problem of degradation of the SAE male boss fitting sealing capability under pressure, temperature and vibration by utilizing a metal to metal seal which has a smaller wetted sealing area than that of a male boss port.

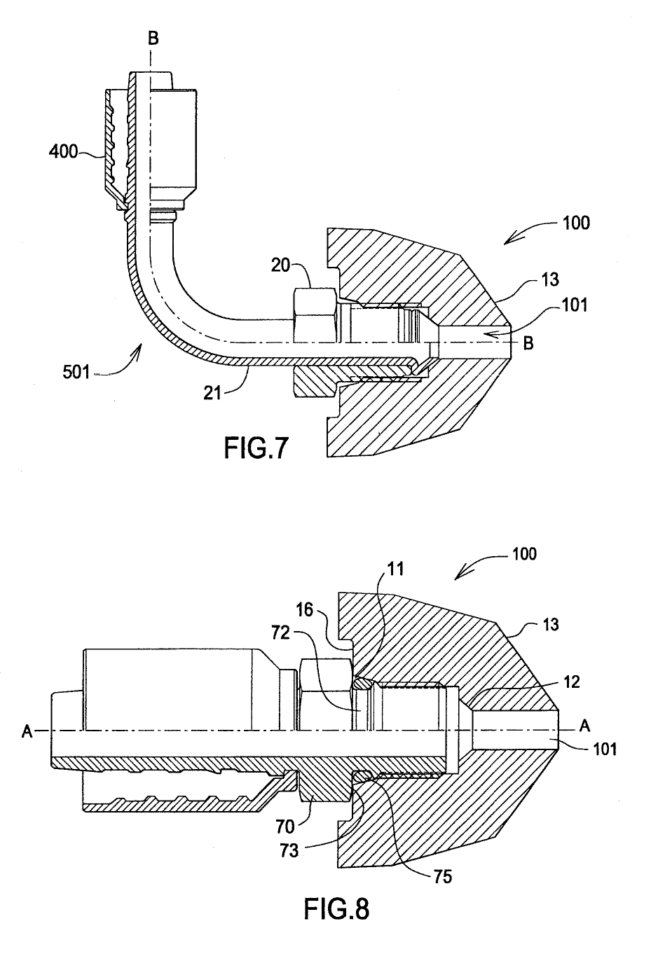

FIG. 7 is a cross-sectional view of a tubing assembly engaged with the hybrid port. The components are as described in FIG. 6, with the exception that a 90° bend is present in tubing 21 along a tubing centerline A-A.

This design overcomes the problems caused by degradation of the SAE male boss adjustable fitting sealing that depend on a clinched washer to prevent the extrusion of the o-ring. The new design allows the fitting to be in the correct rotational position and tightened down resulting in a locked fitting that can simplify equipment assembly and eliminate the need for the male boss adjustable fitting

FIG. 8 is a cross-sectional view of a coupling assembly engaged with the hybrid port. An SAE MALE BOSS male connector 70 is engaged with the port 100. O-ring 75 is compressed between surface 11 and circumferential outer surface 72, thereby forming a pressure seal between the port and the connector 70. Flange surface 73 is in metal to metal contact with port surface 16 which contact determines full engagement of the connector with the port.

Connector 70 is fully compatible with the hybrid port. When used with a connector 70 surface 12 is not in contact with the connector 70.

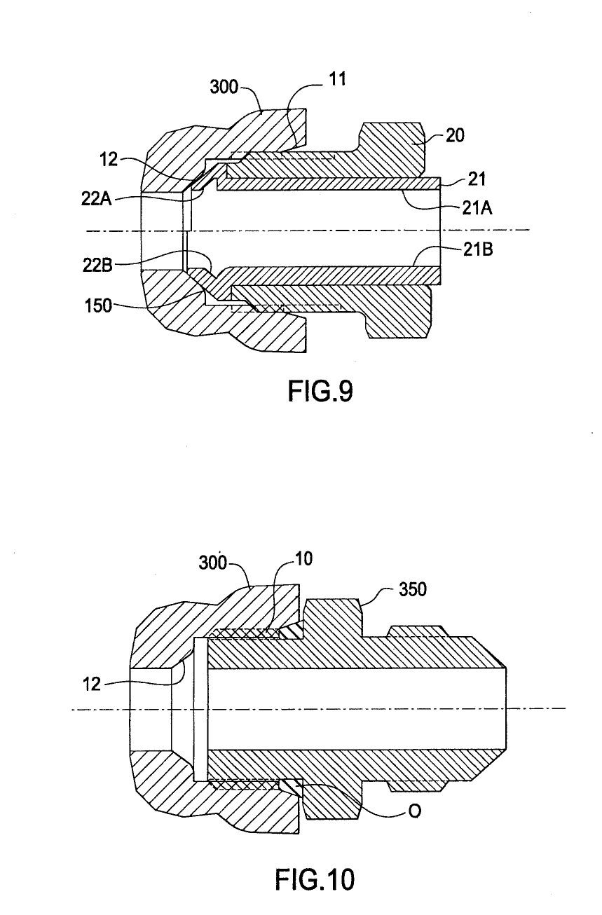

FIG. 9 is a cross-sectional view of the port in FIG. 2D with an MJX tube attached. MJX tubing on a swivel nut 20 is engaged with threaded surface 10. Surface 10 comprises a straight thread. Surface 10 may comprise either a left hand or right hand thread.

Reinforced cone 22 for tubing 21 is compressed between surface 12 and end 23 of swivel nut 20, thereby forming a metal to metal seal. Two different tube thicknesses are shown in FIG. 3, namely, 21A and 21B. Ends 22A and 22B engage surface 150.

FIG. 10 is a cross-sectional view of the port in FIG. 2D with the SAE male boss 350 light duty attached.

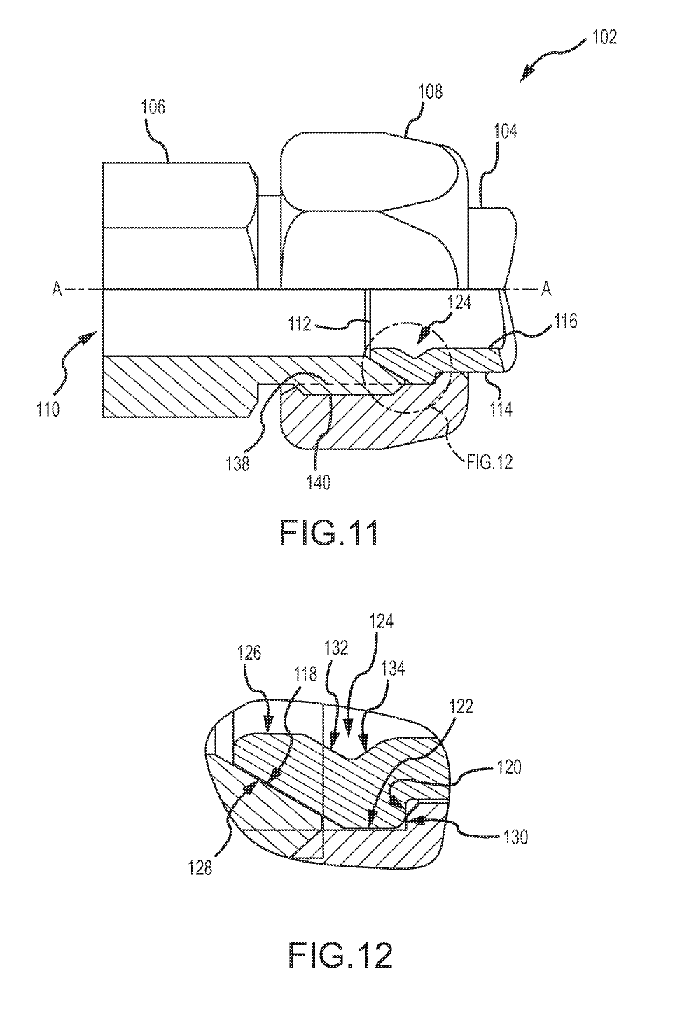

Referring now to FIG. 11, a fluid coupling 102 according to an alternative embodiment of the present disclosure is shown. The example fluid coupling 102 includes a formed tube end 104, an adapter with female cone 106, and a nut 108. The fluid coupling 102 is axially aligned along an axis A-A, and a bore 110 extends through the fluid coupling 102 so that a fluid can flow through the coupling 102. The example bore 110 has a substantially uniform diameter through the coupling 102 to minimize flow pressure losses. The fluid may comprise oil, fuel, water, gas, or any other fluid which is amenable to flow through tube ends or hose.

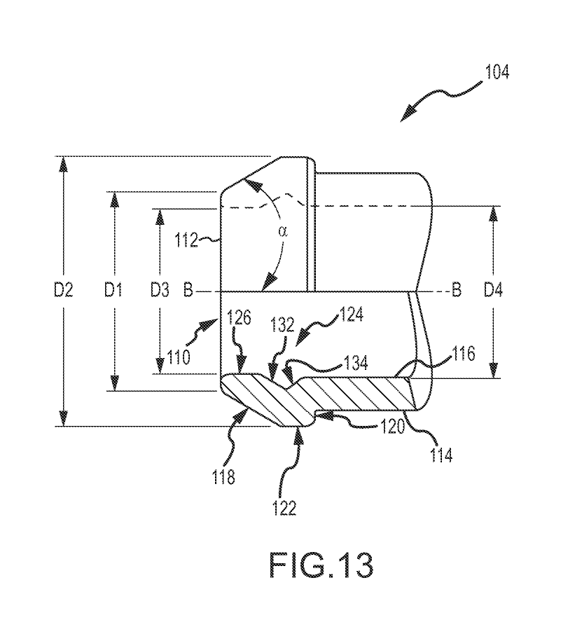

The formed tube end 104, shown in more detail in FIGS. 12-13, generally has a leading edge 112, an outer wall 114, and an inner wall 116. The distance between the outer wall 114 and the inner wall 116 generally defines the thickness of the tube end 104, which may be substantially uniform. The outer wall 114 may include a male tapered seal surface 118, a shoulder 120, and a substantially cylindrical surface 122 positioned between the tapered surface 118 and the shoulder 120. The tapered surface 118 may transition into the leading edge 112 of the tube end 104. The inner wall 116 may include an annular cavity 124 and an optional substantially cylindrical surface 126 positioned between the leading edge 112 of the tube end 104 and the annular cavity 124.

In some embodiments, the tapered surface 118 of the tube end 104 is configured to engage a complementary tapered female surface associated with an adjoining component of a fluid coupling. For example, as depicted in FIGS. 11-12, the male tapered surface 118 engages the female tapered surface 128 of the adapter 106 to create a seal. The male tapered surface 118 may be formed in various shapes, including conical or spherical. The male tapered surface 118 also may be oriented at various angles relative to a longitudinal axis, or centerline, of the formed tube end 104. The example tapered surface 118 depicted in FIGS. 11-13 is conical and is oriented at a cone angle α relative to a longitudinal axis A-A of the tube end 104. In some embodiments, the cone angle α is in the range of approximately 27.5 degrees to approximately 31 degrees. In some embodiments, the cone angle α is in the range of approximately 29 degrees to approximately 30 degrees. In some embodiments, the cone angle α is in the range of approximately 29.25 degrees to approximately 29.75 degrees. In some embodiments, the cone angle α is about 29.5 degrees. The tapered surface 118 depicted in FIGS. 11-13 extends between a minor diameter D1 and a major diameter D2. The minor and major diameters D1, D2 may vary depending on a coupling or pipe standard. In some embodiments, the minor diameter D1 is approximately 15.1 millimeters, and the major diameter D2 is approximately 20.4 millimeters.

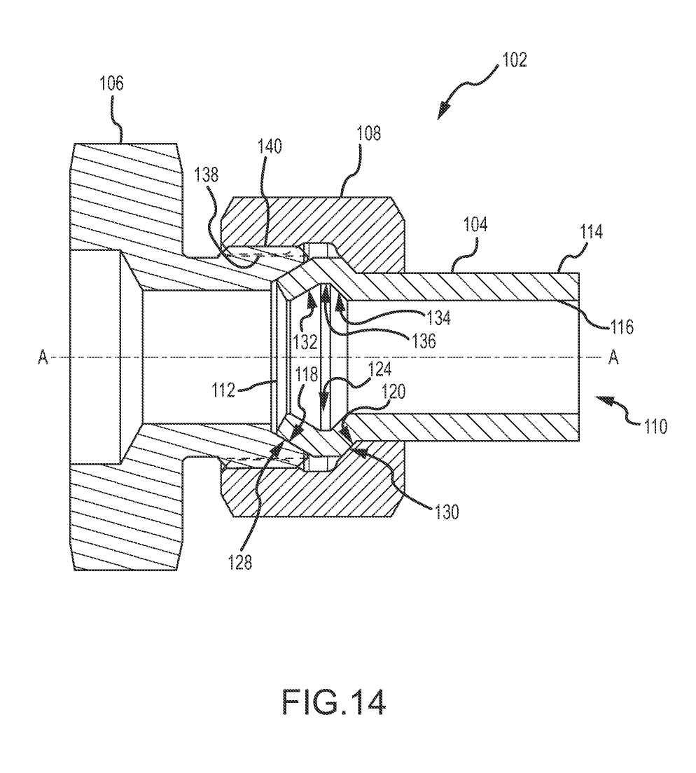

In some embodiments, the shoulder 120 of the formed tube end 104 is configured to engage a corresponding surface of a nut. For example, as depicted in FIGS. 11-12, the shoulder 120 engages a bearing surface 130 of the nut 108 to retain the nut 108 on the tube end 104 and to impart a compression force on the sealing surfaces 118 and 128. The shoulder 120 may be disposed at various orientations relative to the longitudinal axis A-A. For example, as depicted in FIGS. 11-13, the shoulder 120 may be oriented substantially perpendicular to the axis A-A. Alternatively, as depicted in FIG. 14, the shoulder 120 may be tapered relative to the axis A-A. The taper of the shoulder 120 may be formed at various angles, which may generally correspond to the magnitude of the cone angle α. In some embodiments, the shoulder 120 has a back taper with a cone angle of approximately 45 degrees relative to the axis A-A.

In some embodiments, the formed tube end 104 includes a substantially cylindrical surface 122 positioned between the tapered surface 118 and the shoulder 120. The substantially cylindrical surface 122 may define a maximum outer diameter of the tube end 104. The diameter and length of the cylindrical surface 122 may vary depending on the application. As depicted in FIG. 13, the cylindrical surface 122 may be disposed at the major diameter D2 of the tapered surface 118. In the depicted example, the intersection of the cylindrical surface 122 and the shoulder 120 is mostly rounded but in practice may shaped in an indeterminate manor described as ‘as formed’. In some embodiments, the as formed intersection is controlled during a forming process to decrease the size of the intersection so that the bearing surface area between the nut 108 and the shoulder 120 is increased.

In some embodiments, the inner wall 116 of the formed tube end 104 includes an annular cavity 124 configured to improve sealing between the male tapered surface 118 and the female tapered surface 128. In some embodiments, the annular cavity 124 is configured to permit slight deformation of the tube end 104 to improve sealing between the seal surfaces 118, 128. The example annular cavity 124 depicted in FIGS. 11-14 includes a leading surface 132 and a trailing surface 134. The leading surface 132 may be substantially parallel to the tapered male seal surface 118, as depicted in FIGS. 11-14. The trailing surface 134 may be substantially parallel to the shoulder 120, as depicted in FIG. 14. A maximum diameter of the annular cavity 124 may be disposed axially between the leading surface 132 and the trailing surface 134. As illustrated in FIGS. 11-14, the maximum diameter of the annular cavity 124 may be positioned axially between the leading edge 112 of the tube end 104 and the shoulder 120 relative to the longitudinal axis A-A. In some embodiments, the annular cavity 124 is positioned substantially between the leading edge 112 and the shoulder 120 relative to the longitudinal axis A-A. As depicted in FIGS. 11-13, a first substantially cylindrical surface 126 may be positioned axially between the leading edge 112 of the formed tube end 104 and the leading surface 132 of the annular cavity 124 relative to a longitudinal axis A-A. The first substantially cylindrical surface 126 has a diameter D3, which may be approximately equivalent to a diameter D4 of the tube end 104. In one embodiment, the diameter D3 comprises approximately 12.7 millimeters, and the diameter D4 comprises approximately 13.0 millimeters.

Referring to FIG. 14, the annular cavity 124 may include leading surface 132, a trailing surface 134, and a substantially cylindrical surface 136 positioned between the leading surface 132 and the trailing surface 134. The cylindrical surface 136 may define a maximum diameter of the annular cavity, and the surface 136 may be substantially parallel to the cylindrical surface 122 of the outer wall 114 of the formed tube end 104. Surface 136 may vary in size depending upon the wall section of the tube from which 104 is formed. Generally, the tube end 104 depicted in FIG. 14 forms a leading male conical portion, a trailing female conical portion, and a cylindrical portion interposed between the male and female conical portions. In addition, the example tube end 104 has a substantially uniform thickness. Further, the sealing capabilities of the coupling is improved since substantially the entire tapered sealing surface 118 is in contact with the female tapered surface 128.

In some embodiments, the tube end 104 is integrally formed on a tube without utilizing a brazing, crimping, machining, and/or welding process, thereby eliminating the complications and cost associated with those processes. For example, in one embodiment, a punch is used to form the tube end 104. The punch may include a female tapered surface configured to contact a leading edge of the tube end 104 and force the tube end 104 radially inward to form a male tapered surface 118, which may be generally complementary to the female tapered surface. A die cavity may be disposed about an external surface of the tube and positioned relative to a longitudinal axis of the tube so that an end of the tube extends beyond the die. The die may include a recessed area, or socket, configured to seat a deformed portion of the tube. The recessed area, or socket, may be configured to form a shoulder, a cylindrical surface, or both in an outer wall of the tube end. The tube, and the die, or both may be held stationary, while the punch is moved axially to contact the tube end. Alternatively, the punch may be held stationary, while the tube, the die, or both are displaced to contact the punch.

The example fluid coupling 102 depicted in FIGS. 11 and 14 includes a female adapter 106 having a female tapered surface 128 configured to engage the male tapered surface 118. The female tapered surface 128 may be formed in various shapes, including conical or spherical. The female tapered surface 128 may be oriented at various angles relative to a longitudinal axis A-A. In some embodiments, the female tapered surface 128 has an included angle that is slightly larger than an included angle of the male tapered surface 118 to ensure that the male tapered surface 118 seats on an inner diameter of the female tapered surface 128 so that a fluid-tight seal is formed at a minimum diameter of the engaged surfaces. The example adapter 106 includes an externally-threaded section 138 configured to threadably engage a nut 108. Various types of female adapters may be utilized. In addition, although an adapter 106 is depicted, other types of female portions, or couplings, may be utilized. For example, the female tapered surface 128 may be formed in a female coupler, a socket, or a machined port. Further, although not depicted, the female portion may be interconnected to a hose, a tube, a pipe, machinery, or other apparatus for transporting fluid.

The example fluid coupling 102 depicted in FIGS. 11 and 14 further includes a nut 108 configured to threadably engage the externally-threaded section 138 of the adapter 106 to compress the tube end 104 to effect a fluid tight seal between the seal surfaces 118, 128. The example nut 108 includes an internally-threaded section 140 configured to matingly engage the threaded adapter 106. The nut 108 may be disposed and retained about the formed tube end 104. The tube end 104 generally is compressed between the female tapered surface 128 and an internal shoulder 130 of the nut, thereby forming a seal between the seal surfaces 118, 128. The internal shoulder 130 of the nut 108 may be oriented substantially perpendicular to a longitudinal axis A-A, as depicted in FIG. 11, or tapered relative to the axis A-A, as depicted in FIG. 14. In alternative embodiments, the nut 108 may comprise an externally-threaded sleeve that engages an internally-threaded female port. In these alternative embodiments, a leading edge of the nut engages the shoulder 120 of the tube end 104 to compress the tube end 104 as the nut is tightened within the port. In various embodiments, the nut 108 may comprise any suitable nut known in the art.

The foregoing discussion has been presented for purposes of illustration and description and is not intended to limit the disclosure to the form or forms disclosed herein. Further, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A coupling comprised of a formed male tube end configured to operably engage a female portion of an adjoined component, the male tube end having a leading edge, a trailing end with a shoulder and a specific geometry defined therebetween, comprising:
an outer wall with a tapered seal surface extending between said leading edge and said shoulder, and a substantially cylindrical surface positioned between the tapered seal surface and the shoulder, the substantially cylindrical surface defining a maximum outer diameter of the male tube end;
an inner wall defining a bore having a longitudinal axis, the inner wall including an annular cavity having a maximum diameter positioned axially between the leading edge of the male tube end and the shoulder relative to the longitudinal axis, the annular cavity having a leading surface that is substantially parallel to the tapered seal surface, the inner wall further including a substantially cylindrical portion positioned between the leading edge of the male tube end and the leading surface of the annular cavity; and
said female portion of adjoined component comprising a threaded outer surface, an internal bore and a leading edge with a tapered surface adapted to engage substantially the entire length of said tapered seal surface of said outer wall to form a seal.

2. The tube end of claim 1, wherein the shoulder is oriented substantially perpendicular to the longitudinal axis.

3. The coupling of claim 1, wherein said tapered seal surface has a cone angle in the range of approximately 25.5-30.5 degrees relative to a plane defined by the longitudinal axis.

4. The coupling of claim 1, further comprising a nut sized to engage said shoulder of said formed male tube end and having internal threads adapted to engage the external threads of said adjoined component, wherein rotation of said coupling forces said tapered seal surface of said outer wall against said female tapered surface to create a seal.

5. The coupling of claim 1, wherein the female portion comprises a conical seal surface.

6. The coupling of claim 5, wherein the female portion comprises a cone angle between approximately 30.5 and approximately 35.5 degrees relative to a plane defined by the longitudinal axis.

7. The coupling of claim 1, wherein the female portion comprises a spherical seal surface.

8. A male tube end with a deflectable leading edge and tapered sealing surface adapted for selective engagement with a corresponding female surface, the male tube end comprising:
an outer wall including a male tapered surface, a shoulder, and a substantially cylindrical surface positioned between the male tapered surface and the shoulder, the male tapered surface transitioning into the leading edge of the male tube end and oriented at an angle between about 27.5 and 30 degrees with respect to a longitudinal axis defined by a bore of said male tube; and
an inner wall defining a bore having a longitudinal axis, the inner wall including an annular cavity having a maximum diameter positioned axially between the leading edge and the shoulder relative to the longitudinal axis, said annular cavity permitting deflection of said male end leading edge during engagement with a female end internal bore.

9. The tube end of claim 8, wherein the tapered male surface is conical.

10. The tube end of claim 8, wherein the shoulder is oriented substantially perpendicular to the longitudinal axis.

11. The tube end of claim 8, wherein the shoulder comprises a tapered surface.

12. The tube end of claim 8, wherein the substantially cylindrical surface defines a maximum outer diameter of the tube end.

13. The tube end of claim 8, wherein the annular cavity has a leading surface that is substantially parallel to the male tapered surface.

14. The tube end of claim 8, wherein the annular cavity has a trailing surface that is substantially parallel to the shoulder.

15. The tube end of claim 8, wherein the annular cavity has a substantially cylindrical surface defining a maximum inner diameter of the tube end.

16. The tube end of claim 8, wherein the tube end has a substantially uniform thickness.

17. A method of selectively engaging and disengaging a fluid coupling, comprising:
providing a male tube end having a leading edge, an inner wall, an outer wall, and a longitudinal axis, the outer wall including a male tapered surface, a shoulder, and a substantially cylindrical surface positioned between the male tapered surface and the shoulder, the inner wall including an annular cavity having a maximum diameter positioned axially between the leading edge and the shoulder relative to the longitudinal axis;
providing a female adjoined component including a female tapered surface and a threaded section on an exterior surface, the female tapered surface configured to engage the tapered male seal surface; and
providing a threaded nut retained about the male tube end;
threadably engaging the threaded section of the female portion, wherein upon rotation of the nut in a first direction the nut and the female tapered surface compress the tube end to create a fluid tight seal between substantially the entire male tapered surface and at least a portion of the female tapered surface; and
rotating the nut in an opposite direction, such that said male tube end becomes disengaged from said female portion.

18. The method of claim 17, wherein the male tapered surface has a cone angle in the range of approximately 2.75 degrees to approximately 30 degrees relative to the longitudinal axis.

19. The method of claim 17, wherein said cylindrical surface defines a maximum outer diameter of the tube end.

20. The method of claim 17, wherein the annular cavity has a leading surface that is substantially parallel to the male tapered surface, and which provides flexibility in said leading surface to allow deflection upon tightening of said threaded nut.
